(19) United States
(12) Patent Application Publication
(10) Pub. No.: US 2007/0273684 A1
(43) Pub. Date: Nov. 29, 2007

(54) Storage media

(75) Inventors: Chandrasekhar Narayanaswami, Wilton, CT (US); Mandayam Thondanur Raghunath, Fishkill, NY (US)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 11/439,710

(22) Filed: May 24, 2006

(51) Int. Cl. G06T 1/00

(52) U.S. Cl. 345/418

(57) ABSTRACT

The invention broadly and generally provides an apparatus for reading a storage device, such as a DVD, comprising: (a) a reading component for reading stored data from a first data storage element of the aforesaid storage device, the aforesaid first storage element comprising a first storage material; (b) a bookmark writer for writing state data onto a second data storage element of the aforesaid storage device upon discontinuing reading of stored data, the aforesaid state data defining a state of the aforesaid reading component, the aforesaid second storage element comprising a second storage material, the aforesaid second storage material (e.g. magnetic) being different from the aforesaid first storage material; (c) a bookmark reader for reading the aforesaid state data from the aforesaid second data storage element; and (d) a control device operable to return the aforesaid reading component to the aforesaid state upon reading of the aforesaid state data from the aforesaid second data storage element.

### FIELD OF THE INVENTION

The present invention relates generally to data storage and retrieval. According to a preferred embodiment, the present invention relates to portable data storage device and an associated reading (playback) apparatus which together enable the reading of the portable to be stopped on a reading apparatus and later resumed from the state or position in which reading was stopped.

### BACKGROUND OF THE INVENTION

Though DVDs (digital video discs) boast better video quality than video tapes, they suffer from some problems compared to video tapes. For example, when a tape is ejected from a VCR (video cassette recorder), the state at which the tape was paused is retained on the tape. In contrast, when a DVD is ejected from the player, there is no state preserved on the DVD itself. In early DVD players (reading apparatuses), the viewer had to manually get to the point where the DVD was ejected and start playing. Next generation DVD players remember where the DVD was stopped and can resume where it left off even after the player is powered off and then on again. However, with such DVD players, if the DVD that was paused is not the same as the DVD that is resumed, this resume function is not available. More recent DVD players can retain the paused positions for as many as 5 DVDs. The technique used by these players is to read the DVD identification and store bookmark information related to the DVD in a nonvolatile memory on the player itself. No information is stored on the DVD. If the DVD is ejected and played on a different player, no information is available to the new player on where the DVD was paused.

A goal of this invention is to allow convenient suspend and resume while watching DVDs and improve the user experience. An objective is to enhance the current function by being able to pause a DVD in one player and resume it in another DVD player. For example moving the DVD from a portable battery operated player with a small screen to a DVD player connected to an AC power supply, provides a larger display and better sound system.

One could wonder why the DVD pause state information cannot be written on the DVD itself. After all, the DVD can store several GB (gigabytes) of data. The reason is as follows. Optics based storage media such as CD (compact disc) and DVD along with their R and RW variants are capable of storing large amounts of digital data that are written infrequently but read many times. The write operations are expensive and slow. Some media are write once only. Some media require the contents to be erased completely before rewriting. Also in some cases the number of write cycles are limited.

### SUMMARY OF THE INVENTION

The invention broadly and generally provides an apparatus for reading a storage device, comprising: (a) a reading component for reading stored data from a first data storage element of the aforesaid storage device, the aforesaid first storage element comprising a first storage material; (b) a bookmark writer for writing state data onto a second data storage element of the aforesaid storage device upon discontinuing reading of stored data, the aforesaid state data defining a state of the aforesaid reading component, the aforesaid second storage element comprising a second storage material, the aforesaid second storage material being different from the aforesaid first storage material; (c) a bookmark reader for reading the aforesaid state data from the aforesaid second data storage element; and (d) a control device operable to return the aforesaid reading component to the aforesaid state upon reading of the aforesaid state data from the aforesaid second data storage element.

In some embodiments, the aforesaid first storage material is suitable for optical data storage. For example, the first storage element may be a compact disc (CD) or a digital video disk (DVD).

In some embodiments, the aforesaid second storage material is suitable for magnetic data storage. For example, the second material could take the form of a CD or DVD label containing a magnetic strip or ring.

The aforesaid second storage element may be readable in response to a radio frequency request. The reading component of the apparatus may be operable to read from the aforesaid second storage element over a distance.

Preferably, the aforesaid state data may comprise a state of the sequential reading of data contained within the aforesaid first storage element.

Advantageously, the aforesaid stored data in the aforesaid first storage element may comprise at least one file of type selected from the group containing video, audio, text, and computer instructions.

The invention further broadly and generally discloses a portable data storage device comprising: (a) a first storage element and a second storage element; (b) the aforesaid first storage element being operable to store data in a first storage material; and (c) the aforesaid second storage element being operable to store state data in a second storage material, the aforesaid state data referencing a selected portion of the stored data in the aforesaid first storage element, the aforesaid second storage material being different from the aforesaid first storage material.

In some embodiments, the aforesaid first storage element comprises a data storage capacity substantially larger than the data storage capacity of the aforesaid second storage element.

As noted hereinabove, the aforesaid first storage material may preferably be suitable for optical data storage.

Moreover, the aforesaid second storage material may be suitable for magnetic data storage.

According to a preferred embodiment, the aforesaid second storage element may be readable in response to a radio frequency request. In this way the second storage element may be read by a reader at a distance as, for example, to determine which DVD among a group has not yet been played to its end.

Advantageously, the aforesaid state data comprises the state of the sequential reading of data contained within the aforesaid first storage element. Moreover, the aforesaid stored data in the aforesaid first storage element may comprise at least one file of type selected from the group containing video, audio, text, and computer instructions.

According to a preferred embodiment, the aforesaid stored data in the aforesaid first storage element comprises a plurality of hyper-linked documents.

Moreover, the aforesaid state data may preferably comprise a temporal offset from the beginning of a media stream.

Advantageously, the aforesaid state data may comprise references for a plurality of users.

### BRIEF DESCRIPTION OF THE DRAWINGS

FIG. 1 shows an apparatus and portable data storage device in accordance with exemplary aspects of the invention.

### DETAILED DESCRIPTION OF PREFERRED EMBODIMENT

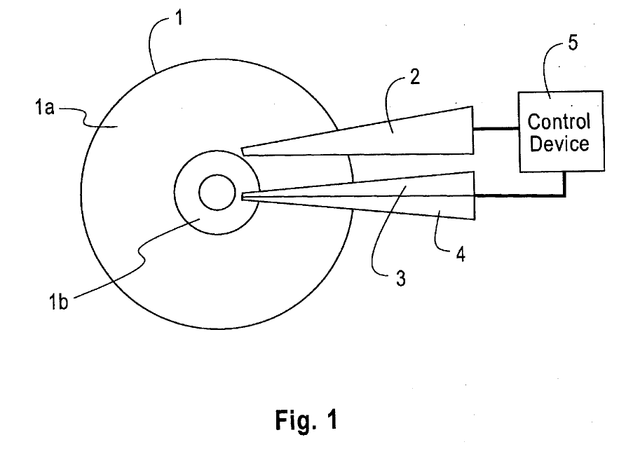

FIG. 1 shows an apparatus 6 and portable data storage device 1 (for example, a DVD) in accordance with exemplary aspects of the invention. The apparatus 6 shown has a reading component 2 for reading stored data (e.g. video, audio, text, a plurality of hyper-linked documents, computer instructions, or a combination thereof) from a first data storage element 1a. The apparatus 6 also comprises a bookmark writer 3 (e.g. a magnetic write head) for writing state data onto a second data storage element 1b of the data storage device 1 upon discontinuing reading of stored data. The second storage element 1b may comprise an area coated with a layer of ferromagnetic material suitable for magnetic data storage. The apparatus 6 also has a bookmark reader 4 for reading state data from the second storage element 1b of the data storage device 1. As shown in FIG. 1, the apparatus 6 also has a control device 5, which is operable to process the state information read by bookmark reader 4 from the magnetic second storage element 1b and to return the reading component 2 to a state stored in the second storage element 1b.

The “state” can include any data relating to the first storage element. For example, state data may comprise the number of times that the first data storage element has been accessed. Such a function can be useful for restricting the number of times the data in the first data storage element 1a is read. State might also contain a reference to the most recently read portion of one or more text, audio, or video files represented on the first storage element 1a. The state may reference a the execution of an application or game stored on the first storage element. In like manner, the state can be used to refer to one or more hyperlinked documents as might be opened and traversed in a web browser.

A benefit of using different storage materials for the first storage element 1a and the second storage element 1b is that specific properties of the different storage materials can be advantageous for different types of data. For example, some data storage materials have a high data storage capacity. Other data storage materials may accept additional data or may permit the erasure of existing data. By using two different data storage materials, the portable data storage device can exhibit data storage and retrieval properties that are more difficult to achieve in portable data storage devices which use only one data storage material.

For example, a DVD-like portable data storage device 1 may have a first storage element 1a which comprises a read-only first storage material containing video data. In this example, the first storage material has a high data-density and is therefore capable of storing a large quantity of data. The second storage element comprises a second storage material which may hold significantly less data. In this example, the second storage material permits writing additional data into storage, but does not permit any erasing of data from the second storage element 1b. Such a portable data storage device can be used as part of a system to prevent the portable data storage device 1 from being read more than a certain number of times.

A benefit of placing both storage elements on the same portable data storage device is that the state data can be kept with the stored data at all times. In this way, an application can be kept with its configuration, a virtual machine can be kept with its state, and a series of documents can be kept with a number of annotations or revisions.

Where a number of users are reading from the first storage element 1a from time to time, a corresponding plurality of state information references may be stored on magnetic element 1b, subject to suitable addressing controls by control device 5 (e.g. each user may identify himself or herself by a personal code).

In some embodiments, it may be advantageous to enable reading from (or writing to) the second storage element at a distance different from that for which the first storage element may be accessed. In one example, a radio frequency request can determine if any media (portable data storage devices) within a 6 foot radius have not been read.

While changes and variations to the embodiments may be made by those skilled in the art of data storage and retrieval, the scope of the invention is to be determined by the appended claims.

What is claimed is:

1. An apparatus for reading a storage device, comprising:
(a) a reading component for reading stored data from a first data storage element of said storage device, said first storage element comprising a first storage material;
(b) a bookmark writer for writing state data onto a second data storage element of said storage device upon discontinuing reading of stored data, said state data defining a state of said reading component, said second storage element comprising a second storage material, said second storage material being different from said first storage material;
(c) a bookmark reader for reading said state data from said second data storage element; and
(d) a control device operable to return said reading component to said state upon reading of said state data from said second data storage element.

2. An apparatus as set forth in claim 1, wherein said first storage material is suitable for optical data storage.

3. An apparatus as set forth in claim 1, wherein said second storage material is suitable for magnetic data storage.

4. An apparatus as set forth in claim 1, wherein said second storage element is readable in response to a radio frequency request.

5. An apparatus as set forth in claim 1, wherein said state data comprises a state of the sequential reading of data contained within said first storage element.

6. An apparatus as set forth in claim 1, wherein said stored data in said first storage element comprises at least one file of type selected from the group containing video, audio, text, and computer instructions.

7. A portable data storage device comprising:
(a) a first storage element and a second storage element;
(b) said first storage element being operable to store data in a first storage material; and
(c) said second storage element being operable to store state data in a second storage material, said state data referencing a selected portion of the stored data in said first storage element, said second storage material being different from said first storage material.

8. A portable data storage device as set forth in claim 7, wherein said first storage element comprises a data storage capacity substantially larger than the data storage capacity of said second storage element.

9. A portable data storage device as set forth in claim 7, wherein said first storage material is suitable for optical data storage.

10. A portable data storage device as set forth in claim 7, wherein said second storage material is suitable for magnetic data storage.

11. An apparatus as set forth in claim 7, wherein said second storage element is readable in response to a radio frequency request.

12. A portable data storage device as set forth in claim 7, wherein said state data comprises the state of the sequential reading of data contained within said first storage element.

13. A portable data storage device as set forth in claim 7, wherein said stored data in said first storage element comprises at least one file of type selected from the group containing video, audio, text, and computer instructions.

14. A portable data storage device as set forth in claim 7, wherein said stored data in said first storage element comprises a plurality of hyper-linked documents.

15. A portable data storage device as set forth in claim 7, wherein said state data comprises a temporal offset from the beginning of a media stream.

16. A portable data storage device as set forth in claim 7, wherein said state data comprises references for a plurality of users.
